(19) United States
(12) Patent Application Publication
(10) Pub. No.: US 2024/0300384 A1
(43) Pub. Date: Sep. 12, 2024

(54) CONTROL METHOD, CONTROL DEVICE, AND VEHICLE

(71) Applicant: HONDA MOTOR CO., LTD, Tokyo (JP)

(72) Inventors: Yuki TANI, Tokyo (JP); Toru OGAKI, Tokyo (JP)

(73) Assignee: HONDA MOTOR CO., LTD, Tokyo (JP)

(21) Appl. No.: 18/590,986

(22) Filed: Feb. 29, 2024

(30) Foreign Application Priority Data
Mar. 10, 2023 (JP) 2023-037645

(51) Int. Cl. B60L 58/27; B60L 58/12; B60L 58/26

(52) U.S. Cl. CPC B60L 58/27; B60L 58/12; B60L 58/26

(57) ABSTRACT

A control method of a vehicle includes: predicting a first charging time that is a charging time at a charging equipment in a case where the temperature of the battery is adjusted so that the first temperature of a first battery module having a relatively high temperature included in a battery reaches the target temperature; predicting a second charging time that is a charging time at the charging equipment in the case where the temperature of the battery is adjusted so that the second temperature of a second battery module having a relatively low temperature included in the battery reaches the target temperature; and adjusting, based on a comparison result between the first charging time and the second charging time, the temperature 10 of the battery so that the first temperature or the second temperature reaches the target temperature.

This application is based upon and claims the benefit of priority from prior Japanese patent application No. 2023-37645, filed on Mar. 10, 2023, the entire contents of which are incorporated herein by reference.

### TECHNICAL FIELD

The present disclosure relates to a control method, a control device, and a vehicle.

### BACKGROUND ART

In recent years, as a specific countermeasure against global climate change, efforts for realizing a low-carbon society or a decarbonized society have become active. Reduction in CO₂ emissions and an improvement in energy efficiency in a vehicle such as an automobile are also required, and electrification of its drive source is progressing. For example, a vehicle (for example, an electric automobile or a hybrid electric automobile) including a motor (also referred to as a “traction motor”) as a drive source that drives drive wheels, and a battery as a power supply that supplies power to the motor is developed.

It is desired that temperature of a battery is desired to appropriate at the start of charging of the battery. For example, JP2021-027797A below discloses a technique in which vehicle use information affecting a state of a battery at an arrival point (for example, a charging station) of a vehicle is acquired, and a target battery temperature of temperature adjustment control performed on the battery is changed from an initial setting value based on the vehicle use information.

### SUMMARY

In a battery having a plurality of battery modules, the temperature may vary for each battery module. Assuming that a temperature of a battery is adjusted before the start of charging without considering such a variation in temperature of each battery module, a charging time may sometimes become longer due to the temperature adjustment.

Aspects of the present disclosure relate to providing a control method, a control

device, and a vehicle capable of appropriately adjusting a temperature of a battery having a plurality of battery modules before a vehicle arrives at charging equipment scheduled for charging. This further contributes to improvement in energy efficiency.

According to an aspect of the present disclosure, there is provided a control method of a vehicle, the vehicle including a battery having a plurality of battery modules and a temperature adjustment device configured to adjust a temperature of the battery, the control method executed by a computer, to control the vehicle, configured to adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, the control method including:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.

According to another aspect of the present disclosure, there is provided a control device that controls a vehicle including a battery having a plurality of battery modules and a temperature adjustment device configured to adjust a temperature of the battery, in which
the control device is configured to
adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, and
the control device includes a processing unit configured to perform the following processing:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.

According to another aspect of the present disclosure, there is provided a vehicle including:
a battery having a plurality of battery modules;
a temperature adjustment device configured to adjust a temperature of the battery; and
a control device configured to adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, in which
   the control device includes a processing unit configured to perform a process including:
      deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
      predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
      deriving, based on the temperature difference, a second predicted value that is a predicted value of the first temperature at the time of arrival at the charging equipment in a case where the temperature of the battery is adjusted so that the second temperature reaches the target temperature;
      predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
      adjusting, based on a comparison result between the first charging time and the second charging time, the temperature of the battery so that the first temperature or the second temperature reaches the target temperature.

According to aspects of the present disclosure, it is possible to provide a control method, a control device, and a vehicle capable of appropriately adjusting a temperature of a battery having a plurality of battery modules before a vehicle arrives at charging equipment scheduled for charging. This further contributes to improvement in energy efficiency.

### BRIEF DESCRIPTION OF DRAWINGS

Exemplary embodiment(s) of the present invention will be described in detail based on the following figures, wherein:

FIG. 1 shows a vehicle 10 equipped with a battery 11 whose temperature is to be adjusted;

FIG. 2 shows an example of the battery 11 and a temperature adjustment device 15;

FIGS. 3A and 3B show an example of a temperature adjustment method for the battery 11 performed by a control device 17;

FIG. 4 shows a specific example of temperature adjustment on the battery 11 performed by the control device 17;

FIG. 5 is a flowchart showing an example of processing executed by the control device 17;

FIG. 6 shows another specific example of the temperature adjustment on the battery 11 performed by the control device 17;

FIG. 7 is a flowchart (part 1) showing another example of the processing executed by the control device 17; and

FIG. 8 is a flowchart (part 2) showing another example of the processing executed by the control device 17.

### DESCRIPTION OF EMBODIMENTS

Hereinafter, an embodiment of a control method, a control device, and a vehicle of the present disclosure will be described in detail with reference to the drawings. In the following description, front and rear, left and right, and up and down are described according to directions viewed from a user (for example, a driver) of a vehicle. Further, the drawings are to be viewed according to an orientation of the reference numerals. The following embodiment does not limit 30 the disclosure described in the claims, and not all combinations of features described in the embodiment are essential to the disclosure. Two or more of features among the features described in the embodiment may be combined freely. In addition, in the following description, the same or similar elements are denoted by the same or similar reference numerals, and the description thereof may be omitted or simplified as appropriate.

### Vehicle

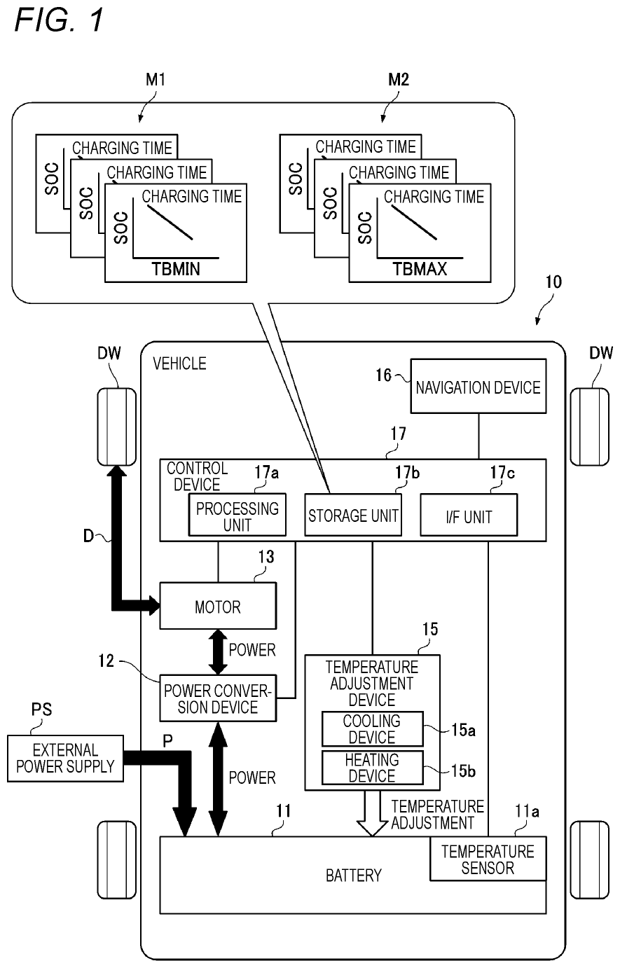

First, an example of a vehicle equipped with a battery whose temperature is to be adjusted (temperature adjusted) by a control method according to the present disclosure will be described. As shown in FIG. 1, a vehicle 10 according to the present embodiment is an electric automobile including a battery 11 that is a chargeable and dischargeable secondary battery, a motor 13 configured to drive drive wheels DW by being supplied with power from the battery 11, and a power conversion device 12 that converts power transferred between the battery 11 and the motor 13.

The battery 11 is configured to be charged with power P received from an external power supply PS, for example. The external power supply PS is, for example, a commercial power supply that supplies alternating current having a predetermined voltage (for example, 100 [V] to 200 [V]) and a predetermined frequency (for example, 50 [Hz] to 60 [Hz]).

Specifically, the vehicle 10 is configured to be electrically connectable to the external power supply PS. Electrical connection between the vehicle 10 and the external power supply PS may be established by a physical connector, a cable, or the like, or may be established by wireless power transfer. In a case where the wireless power transfer is adopted, a method of power transfer may be an electromagnetic induction type, a magnetic resonance type, a combination of the electromagnetic induction type and the magnetic resonance type, or the like.

The power P received from the external power supply PS is converted from alternating current (AC) to direct current (DC) by a charger (not shown) included in the vehicle 10, is converted to a voltage suitable for charging the battery 11, and then is supplied to the battery 11. Accordingly, the vehicle 10 may charge the battery 11 with the power P received from the external power supply PS.

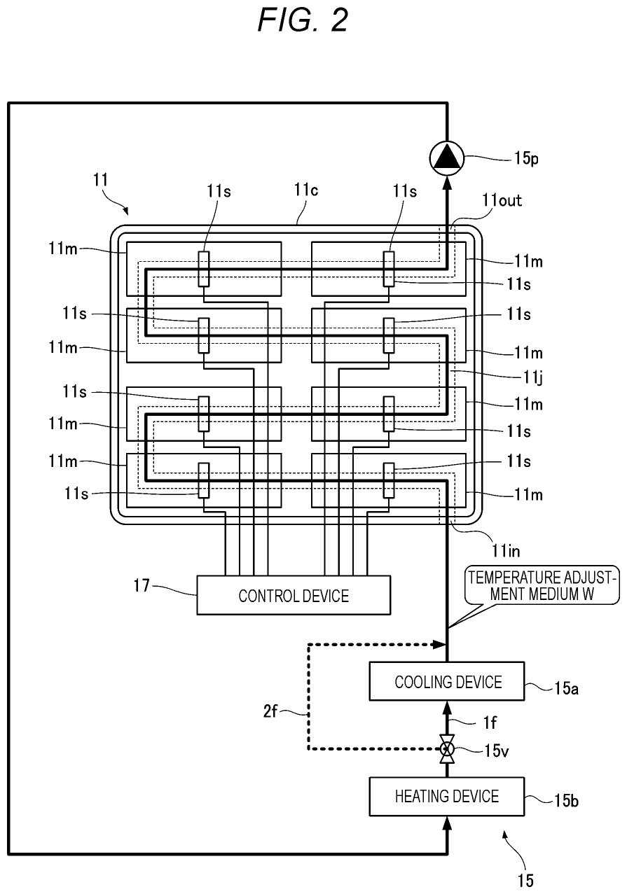

The battery 11 is configured to output a high voltage (for example, 100 [V] to 400 [V]) by connecting a plurality of battery modules 11m (see FIG. 2) each having one or a plurality of storage cells in series, and is connected to the motor 13 via the power conversion device 12. For example, a lithium-ion battery, a nickel-metal hydride battery, or the like may be used as the storage cell of the battery 11.

The battery 11 is provided with a temperature sensor 11s that detects a temperature of the battery 11. A detection signal indicating the temperature of the battery 11 detected by the temperature sensor 11s is sent to a control device 17 to be described later. In the present embodiment, the temperature sensor 11s is provided for each battery module 11m constituting the battery 11, and the temperature sensor 11s detects a temperature of each battery module 11m, the detail of which will be described later.

The power conversion device 12 includes an inverter, converts direct current output from the battery 11 into alternating current, and supplies the converted alternating current to the motor 13 implemented by an alternating current motor (for example, a three-phase alternating current motor). The power conversion device 12 may further include, for example, a DC/DC converter, and convert a voltage of the power transferred between the battery 11 and the motor 13.

The motor 13 is connected to the drive wheels DW via a power transmission device (not shown) included in the vehicle 10, and outputs, to the drive wheels DW, a driving force (driving force for traveling) D for driving the vehicle 10 by being supplied with power. Therefore, the vehicle 10 may travel with the driving force output by the motor 13 by supplying the power of the battery 11 to the motor 13. That is, the motor 13 is a so-called “traction motor”.

The motor 13 may also perform regenerative power generation in braking of the vehicle 10 and output the generated power (alternating current) to the power conversion device 12. In this case, the power conversion device 12 converts alternating current output from the motor 13 into direct current and supplies the converted direct current to the battery 11. Accordingly, the vehicle 10 may also charge the battery 11 with the power generated by the motor 13 in braking of the vehicle 10.

The vehicle 10 further includes a temperature adjustment device 15 configured to adjust a temperature of the battery 11, a navigation device 16 that navigates the traveling of the vehicle 10, and a control device 17 that comprehensively controls the entire vehicle 10.

The temperature adjustment device 15 performs the temperature adjustment on the battery 11 under the control of the control device 17. In the present embodiment, the temperature adjustment device 15 includes a cooling device 15a as a chiller capable of cooling the battery 11 and a heating device 15b as a heater capable of heating the battery 11, and is configured to perform cooling and heating of the battery 11 as the temperature adjustment of the battery 11.

The navigation device 16 includes, for example, a global navigation satellite system (GNSS) receiver capable of specifying a current position of the vehicle 10, and determines, with reference to map data or the like stored in advance, a route (hereinafter, also referred to as a “guidance route”) from the current position specified by the GNSS receiver to a destination set by a user (for example, a driver) of the vehicle 10. At this time, for example, when it is predicted that a remaining capacity (hereinafter, also referred to as “state of charge (SOC)”) of the battery 11 is equal to or smaller than a predetermined value on the way to the destination, the navigation device 16 determines a guidance route including, as a via-point, charging equipment (for example, a so-called charging station) capable of charging the battery 11.

When the navigation device 16 determines the guidance route, the navigation device 16 displays the determined guidance route on a display (not shown) of the vehicle 10 or the like to provide guidance to the user. Accordingly, the vehicle 10 may travel along the guidance route. That is, the guidance route is a route along which the vehicle 10 is scheduled to travel (hereinafter, also referred to as a “scheduled travel route”). The navigation device 16 outputs information indicating the determined guidance route, that is, the scheduled travel route, to the control device 17 to be described later.

The control device 17 is a computer that comprehensively controls the entire vehicle 10 including the power conversion device 12, the motor 13, and the temperature adjustment device 15, and is an example of the control device according to the present disclosure. The control device 17 is implemented by, for example, an electric control unit (ECU). The control device 17 may be implemented by one ECU, or may be implemented by a cooperation of a plurality of ECUs.

The control device 17 includes a processing unit 17a, a storage unit 17b such as a random access memory (RAM) and a read only memory (ROM), and an I/F unit 17c (interface unit) that controls input and output of data between the inside and the outside of the control device 17.

The processing unit 17a is a processor such as a central processing unit (CPU), and executes a program stored in the storage unit 17b. The storage unit 17b stores, in addition to the program executed by the processing unit 17a, data used by the processing unit 17a for processing, such as a first charging time map M1 and a second charging time map M2. Details of the first charging time map M1 and the second charging time map M2 will be described later.

For example, the control device 17 (in other words, the processing unit 17a) controls the temperature adjustment device 15 to adjust the temperature of the battery 11. Since details of the temperature adjustment method for the battery 11 which is performed by the control device 17 will be described later, the description thereof is omitted here.

### Battery and Temperature Adjustment Device

As shown in FIG. 2, the battery 11 includes a plurality of battery modules 11m and a battery case 11c that houses the battery modules 11m. Each battery module 11m is provided with the temperature sensor 11s, and a detection signal of each temperature sensor 11s is sent to the control device 17. Accordingly, the control device 17 may acquire the temperature of each battery module 11m.

A bottom surface of the battery case 11c (that is, a surface on which each battery module 11m is placed) is provided with, for example, a water jacket 11j serving as a flow path of a temperature adjustment medium W realized by cooling water such as a long life coolant (LLC). The water jacket 11j is provided, for example, on the bottom surface of the battery case 11c so as to pass under a portion where each battery module 11m is placed without overlapping. The temperature adjustment device 15 adjusts the temperature of the battery 11 by circulating the temperature adjustment medium W through the water jacket 11j. In the example shown in FIG. 2, the cooling device 15a and the heating device 15b are provided upstream of the battery 11 and a pump 15p is provided downstream of the battery 11 in a circulation path (arrow indicated by a thick solid line in FIG. 2) of the temperature adjustment medium W. The pump 15p is an electric pump that pumps the temperature adjustment medium W, and is controlled by the control device 17.

The cooling device 15a includes, for example, a radiator (not shown), and may cool the temperature adjustment medium W by heat exchange with the outside air via the radiator. Further, the heating device 15b includes, for example, an electric heater (not shown), and may control heating of the temperature adjustment medium W by controlling power supply to the electric heater.

As an example, in the present embodiment, a flow path switching valve 15v realized by a three-way valve or the like is provided between the cooling device 15a and the heating device 15b. The flow path switching valve 15v is configured to switch a flow path of the temperature adjustment medium W from the heating device 15b between a first flow path 1f that guides the temperature adjustment medium W to the cooling device 15a as indicated by a solid arrow and a second flow path 2f that bypasses the cooling device 15a as indicated by a broken arrow.

In a case where the flow path of the temperature adjustment medium W from the heating device 15b is the first flow path 1f, the temperature adjustment medium W is cooled by the cooling device 15a and supplied to the battery 11. On the other hand, in the case of the second flow path 2f, since the temperature adjustment medium W from the heating device 15b bypasses the cooling device 15a, the temperature adjustment medium W is supplied to the battery 11 without being cooled. The flow path switching valve 15v is configured as, for example, an electrically controllable solenoid valve, and is controlled by the control device 17.

In a case where the battery 11 is cooled in the temperature adjustment of the battery 11 by the temperature adjustment device 15, the control device 17 may operate the cooling device 15a while not supplying power to the electric heater of the heating device 15b, and control the flow path switching valve 15v such that the flow path of the temperature adjustment medium W from the heating device 15b becomes the first flow path 1f. In a case where the battery 11 is heated in the temperature adjustment of the battery 11 by the temperature adjustment device 15, the control device 17 may control the flow path switching valve 15v such that the flow path of the temperature adjustment medium W from the heating device 15b becomes the second flow path 2f after supplying power to the electric heater of the heating device 15b. The configuration of the temperature adjustment device 15 described here is merely an example, and the present disclosure is not limited thereto. The specific configuration of the temperature adjustment device 15 is not particularly limited as long as the temperature adjustment device 15 may cool and heat the battery 11 under the control of the control device 17.

### Temperature Adjustment on Battery Performed by Control Device

At the start of charging, the battery 11 is desired to have an appropriate temperature. Therefore, in a case where the battery 11 is scheduled to be charged at the charging equipment included in a scheduled travel route of the vehicle 10 (in other words, in a case where the scheduled travel route includes the charging equipment), the control device 17 adjusts the temperature of the battery 11 by the temperature adjustment device 15 so that the temperature of the battery 11 at the time of arrival at the charging equipment reaches a predetermined target temperature Tg. Here, as the target temperature Tg, for example, a predetermined temperature suitable for charging is determined in advance by a manufacturer of the vehicle 10 from hardware characteristics or the like of the battery 11. Accordingly, the control device 17 may set the battery 11 to an appropriate temperature (that is, a temperature suitable for charging) in advance before arrival at charging equipment scheduled for charging, and may start charging the battery 11 immediately after arrival at the charging equipment. Therefore, compared to the case where the temperature of the battery 11 is adjusted after arrival at the charging equipment, a charging time at the charging equipment can be shortened, and convenience can be improved. Here, the charging time is, for example, a time required to bring the battery 11 into a fully charged state.

The control device 17 may vary the target temperature Tg in accordance with charging power of the battery 11 at the charging equipment scheduled for charging (hereinafter, also simply referred to as “charging power”). In this way, it is possible to set the battery 11 to an appropriate temperature in consideration of the charging power before arrival at the charging equipment scheduled for charging. Here, the charging power may be, for example, an upper limit output (that is, output performance) of the charging equipment scheduled for charging. The charging power may be a larger one of the upper limit output of the charging equipment scheduled for charging and an upper limit of the power that the battery 11 is able to receive.

In the battery 11 having the plurality of battery modules 11m, the temperature may vary for each battery module 11m. For example, in a case where the battery 11 is heated by the heating device 15b, it is difficult for hot water heated by the heating device 15b to reach a portion near an outlet 11 out which is an end downstream of the water jacket 11j in the circulation path of the temperature adjustment medium W. Thus, in this case, the battery module 11m closer to the outlet 11 out is less likely to be warmed. On the other hand, in a case where the battery 11 is cooled by the cooling device 15a, the temperature of the temperature adjustment medium W in the water jacket 11j increases as the temperature adjustment medium W approaches the outlet 11 out from an inlet 11 in which is an end upstream of the water jacket 11j in the circulation path of the temperature adjustment medium W. Thus, in this case, the battery module 11m closer to the outlet 11 out is less likely to be cooled. Further, the closer the battery module 11m is placed to the outside of the battery case 11c, the more easily the battery module 11m is affected by the outside air. Therefore, the temperature of the battery module 11m tends to be high when the temperature of the outside air is high, and the temperature of the battery module 11m tends to be low when the temperature of the outside air is low.

Due to these factors, in the battery 11, the temperature may vary for each battery module 11m. When the temperature of each battery module 11m varies, a situation may occur in which it is preferable to heat the battery 11 before arrival at the charging equipment if the temperature of the battery module 11m having a relatively low temperature is used as a reference, and on the other hand, it is preferable to cool the battery 11 before arrival at the charging equipment if the temperature of the battery module 11m having a relatively high temperature is used as a reference.

In a case where such a situation occurs, assuming that the battery 11 is uniformly heated with reference to the temperature of the battery module 11m having a relatively low temperature, the temperature of the battery module 11m having a relatively high temperature becomes too high, and the battery 11 may not be charged efficiently. Conversely, when the battery 11 is uniformly cooled with reference to the temperature of the battery module 11m having a relatively high temperature, the temperature of the battery module 11m having a relatively low temperature may become too low, and the battery 11 may not be charged efficiently. Therefore, assuming that uniform temperature adjustment is performed before arrival at the charging equipment without considering the variation in temperature of each battery module 11m, a situation may occur in which the charging time at the charging equipment becomes longer due to the temperature adjustment.

Therefore, the control device 17 compares a charging time at the charging equipment in a case where the temperature adjustment (for example, cooling) is performed before arrival at the charging equipment so that the temperature of the battery module 11m having a relatively high temperature reaches the target temperature Tg with a charging time at the charging equipment in a case where the temperature adjustment (for example, heating) is performed before arrival at the charging equipment so that the temperature of the battery module 11m having a relatively low temperature reaches the target temperature Tg, and determines the temperature adjustment to be performed before arrival at the charging equipment based on a comparison result.

Hereinafter, the temperature adjustment method for the battery 11 performed by the control device 17 will be described in more detail. Hereinafter, among the plurality of battery modules 11m of the battery 11, a battery module 11m having the highest temperature is also referred to as a “first battery module 11m”, and a temperature of the first battery module 11m is also referred to as a “first temperature TBMAX”. Hereinafter, among the plurality of battery modules 11m of the battery 11, a battery module 11m having the lowest temperature is also referred to as a “second battery module 11m”, and a temperature of the second battery module 11m is also referred to as a “second temperature TBMIN”. The control device 17 may acquire the first temperature TBMAX and the second temperature TBMIN based on detection signals received from the respective temperature sensors 11s provided in the respective battery modules 11m.

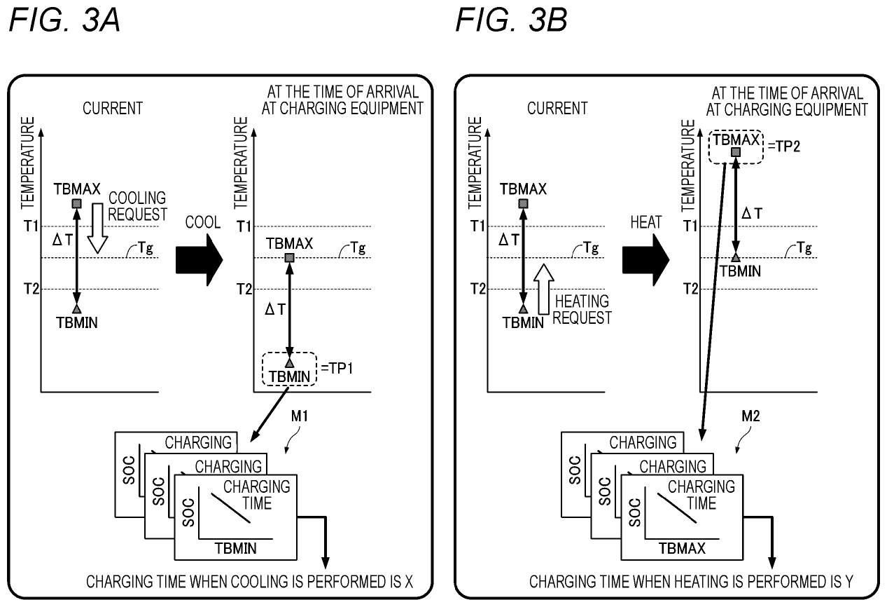

As shown in FIG. 3A, for example, it is assumed that the current first temperature TBMAX is equal to or higher than T1 and the current second temperature TBMIN is equal to or lower than T2, the current first temperature TBMAX and the current second temperature TBMIN being the first temperature TBMAX and the second temperature TBMIN at any time before arrival at the charging equipment scheduled for charging. Here, T1 is a temperature predetermined by the manufacturer of the vehicle 10 or the like as a condition for cooling the battery 11. T2 is a temperature predetermined by the manufacturer of the vehicle 10 or the like as a condition for heating the battery 11. It is assumed that the target temperature Tg described above is, for example, higher than T2 and lower than T1 (that is, T2 <target temperature Tg<T1).

In this case, the processing unit 17a of the control device 17 first derives a current temperature difference ΔT between the first temperature TBMAX and the second temperature TBMIN. The current temperature difference ΔT may be derived by subtracting the second temperature TBMIN from the first temperature TBMAX.

Next, the processing unit 17a derives, based on the current temperature difference ΔT, a first predicted value TP1 that is a predicted value of the second temperature TBMIN at the time of arrival at the charging equipment in a case where the temperature of the battery 11 is adjusted so that the first temperature TBMAX reaches the target temperature Tg. As shown in FIG. 3A, for example, the processing unit 17a derives, as the first predicted value TP1, a temperature obtained by subtracting the temperature difference ΔT from the target temperature Tg.

Next, based on a predicted value of SOC of the battery 11 at the time of arrival at the charging equipment (hereinafter, also simply referred to as “SOC of the battery 11 at the time of arrival at the charging equipment”) and the first predicted value TP1, the processing unit 17a predicts a first charging time X that is a charging time at the charging equipment in the case where the temperature of the battery 11 is adjusted (here, cooled) so that the first temperature TBMAX reaches the target temperature Tg. As shown in FIG. 3A, for example, the processing unit 17a refers to the first charging time map M1 stored in the storage unit 17b, and predicts the first charging time X based on the SOC of the battery 11 at the time of arrival at the charging equipment and the derived first predicted value TP1.

Here, the first charging time map M1 is, for example, a map (information) that defines a predicted value of the charging time for each combination of the SOC of the battery 11 and the second temperature TBMIN at the charging equipment. As an example, it is assumed that the SOC of the battery 11 at the time of arrival at the charging equipment is predicted as α [%] and the temperature derived as the first predicted value TP1 is β [° C.]. In this case, the processing unit 17a derives, as the first charging time X, a charging time “γ [min]” associated with the SOC “α [%]” of the battery 11 and the second temperature TBMIN “β [° C.]” in the first charging time map M1.

The first charging time map M1 may be a map that defines a predicted value of the charging time for each combination of the SOC of the battery 11 and the second temperature TBMIN at the charging equipment for each upper limit output of the charging equipment. As an example, it is assumed that the upper limit output of the charging equipment scheduled for charging is δ [Wh], the SOC of the battery 11 at the time of arrival at the charging equipment is predicted to be α [%], and the temperature derived as the first predicted value TP1 is β [° C.]. In this case, the processing unit 17a may derive, as the first charging time X, the charging time “γ [min]” associated with the upper limit output “δ [Wh]” of the charging equipment, the SOC “α [%]” of the battery 11, and the second temperature TBMIN “β [° C.]” in the first charging time map M1.

Next, as shown in FIG. 3B, the processing unit 17a derives, based on the current temperature difference ΔT, a second predicted value TP2 that is a predicted value of the first temperature TBMAX at the time of arrival at the charging equipment in a case where the temperature of the battery 11 is adjusted so that the second temperature TBMIN reaches the target temperature Tg. As shown in FIG. 3B, for example, the processing unit 17a derives, as the second predicted value TP2, a temperature obtained by adding the temperature difference ΔT to the target temperature Tg.

Next, based on the SOC of the battery 11 at the time of arrival at the charging equipment and the second predicted value TP2, the processing unit 17a predicts a second charging time Y that is a charging time at the charging equipment in the case where the temperature of the battery 11 is adjusted so that the second temperature TBMIN reaches the target temperature Tg. As shown in FIG. 3B, for example, the processing unit 17a refers to the second charging time map M2 stored in the storage unit 17b, and predicts the second charging time Y based on the SOC of the battery 11 at the time of arrival at the charging equipment and the derived second predicted value TP2.

Here, the second charging time map M2 is, for example, a map that defines a predicted value of the charging time for each combination of the SOC of the battery 11 and the first temperature TBMAX at the charging equipment. As an example, it is assumed that the SOC of the battery 11 at the time of arrival at the charging equipment is predicted as α [%] and the temperature derived as the second predicted value TP2 is ε [° C.]. In this case, the processing unit 17a derives, as the second charging time Y, a charging time “ξ [min]” associated with the SOC “α [%]” of the battery 11 and the first temperature TBMAX “ε [° C.]” in the second charging time map M2.

The second charging time map M2 may be a map that defines a predicted value of the charging time for each combination of the SOC of the battery 11 and the first temperature TBMAX at the charging equipment for each upper limit output of the charging equipment. As an example, it is assumed that the upper limit output of the charging equipment scheduled for charging is δ [Wh], the SOC of the battery 11 at the time of arrival at the charging equipment is predicted to be a [%], and the temperature derived as the second predicted value TP2 is ε [° C.]. In this case, the processing unit 17a may derive, as the second charging time Y, the charging time “ζ [min]” associated with the upper limit output “δ [Wh]” of the charging equipment, the SOC “α [%]” of the battery 11, and the first temperature TBMAX “ε [° C.]” in the second charging time map M2.

The processing unit 17a adjusts the temperature of the battery 11 so that the first temperature TBMAX or the second temperature TBMIN reaches the target temperature Tg based on a comparison result between the first charging time X and the second charging time Y. For example, in a case where the first charging time X is equal to or shorter than the second charging time Y, the processing unit 17a cools the battery 11 so that the first temperature TBMAX at the time of arrival at the charging equipment scheduled for charging reaches the target temperature Tg. On the other hand, in a case where the first charging time X is longer than the second charging time Y, the processing unit 17a heats the battery 11 so that the second temperature TBMIN at the time of arrival at the charging equipment scheduled for charging reaches the target temperature Tg.

As described above, the control device 17 (processing unit 17a) derives the first predicted value TP1 based on the current temperature difference ΔT, and predicts the first charging time X based on the SOC of the battery 11 at the time of arrival at the charging equipment scheduled for charging and the first predicted value TP1. The control device 17 derives the second predicted value TP2 based on the current temperature difference ΔT, and predicts the second charging time Y based on the SOC of the battery 11 at the time of arrival at the charging equipment scheduled for charging and the second predicted value TP2. Further, based on the comparison result between the first charging time X and the second charging time Y, the control device 17 adjusts the temperature of the battery 11 so that the first temperature TBMAX or the second temperature TBMIN at the time of arrival at the charging equipment scheduled for charging reaches the target temperature Tg. Accordingly, before the vehicle 10 arrives at the charging equipment scheduled for charging, it is possible to appropriately adjust the temperature of the battery 11 having the plurality of battery modules 11m so that the charging time at the charging equipment becomes shorter. Therefore, it is possible to prevent the charging time from becoming longer and improve convenience.

More specifically, in a case where the first charging time X is shorter than the second charging time Y, the control device 17 adjusts the temperature of the battery 11 (for example, cools the battery 11) so that the first temperature TBMAX at the time of arrival at the charging equipment scheduled for charging reaches the target temperature Tg. On the other hand, in a case where the second charging time Y is shorter than the first charging time X, the control device 17 adjusts the temperature of the battery 11 (for example, heats the battery 11) so that the second temperature TBMIN at the time of arrival at the charging equipment scheduled for charging reaches the target temperature Tg. Accordingly, among the temperature adjustment such that the first battery module 11m having a relatively high temperature among the plurality of battery modules 11m of the battery 11 reaches the target temperature Tg and the temperature adjustment such that the second battery module 11m having a relatively low temperature among the plurality of battery modules 11m of the battery 11 reaches the target temperature Tg, it is possible to perform the one that makes the charging time at the charging equipment scheduled for charging shorter, and it is possible to appropriately adjust the temperature so that the charging time at the charging equipment becomes shorter. Therefore, it is possible to prevent the charging time from becoming longer and improve convenience.

As described above, the control device 17 may predict the first charging time X based on the SOC of the battery 11 at the time of arrival at the charging equipment scheduled for charging, the first predicted value TP1, and the upper limit output (that is, output performance) of the charging equipment. Similarly, the control device 17 may predict the second charging time Y based on the SOC of the battery 11 at the time of arrival at the charging equipment scheduled for charging, the second predicted value TP2, and the upper limit output of the charging equipment. In this way, the control device 17 may selectively perform either the temperature adjustment such that the first battery module 11m reaches the target temperature Tg or the temperature adjustment such that the second battery module 11m reaches the target temperature Tg in consideration of the upper limit output (that is, output performance) of the charging equipment.

In addition, compared to a case where the first charging time X is acquired by calculation, the control device 17 predicts the first charging time X using the first charging time map M1. Thus, the first charging time X may be predicted while reducing a processing load. Similarly, compared to a case where the second charging time Y is acquired by calculation, the control device 17 predicts the second charging time Y using the second charging time map M2. Thus, the second charging time Y may be predicted while reducing a processing load.

### Specific Example of Temperature Adjustment on Battery Performed by Control Device

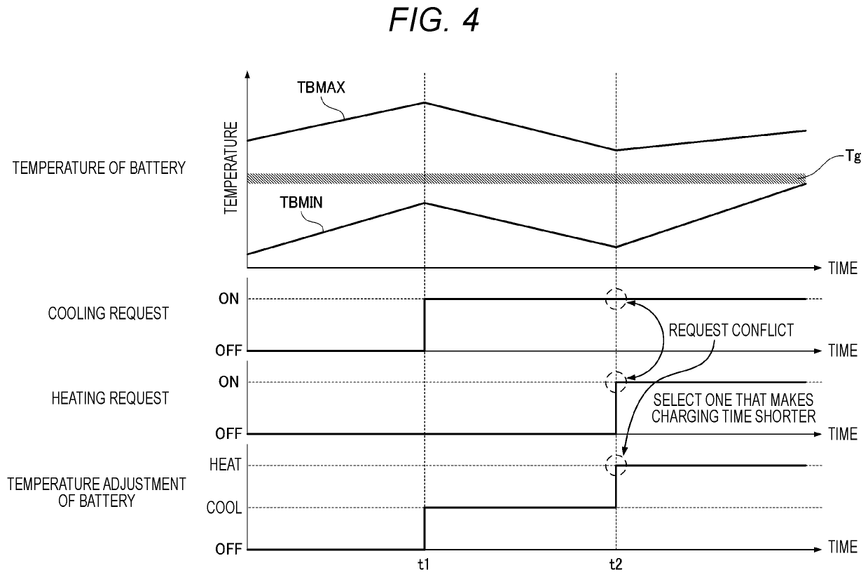

Next, a specific example of temperature adjustment on the battery 11 performed by the control device 17 will be described with reference to FIG. 4. In the example shown in FIG. 4, it is assumed that the first temperature TBMAX is equal to or higher than T1 at time t1 when a distance or required time to the charging equipment scheduled for charging is equal to or less than a predetermined value (that is, when the vehicle 10 approaches the charging equipment scheduled for charging to some extent), and a cooling request is generated. However, at this time, the second temperature TBMIN is still higher than T2, and no heating request is generated. In such a case, the control device 17 starts to cool the battery 11 from time t1 so that the first temperature TBMAX reaches the target temperature Tg. Accordingly, the temperature of each battery module 11m of the battery 11 decreases from time t1.

It is assumed that, at time t2 after time t1, the second temperature TBMIN is equal to

or lower than T2 and a heating request is generated. At this time, the first temperature TBMAX is still equal to or higher than T1, and the cooling request continues to be generated. In this way, in a case where the first temperature TBMAX is equal to or higher than T1 and the second temperature TBMIN is equal to or lower than T2, and the cooling request and the heating request conflict with each other, the control device 17 predicts the first charging time X and the second charging time Y as described above, and selectively performs the temperature adjustment that makes the charging time at the charging equipment scheduled for charging shorter based on the comparison result. In the example shown in FIG. 4, since the second charging time Y is shorter than the first charging time X, the control device 17 heats the battery 11 so that the second temperature TBMIN reaches the target temperature Tg from time t2.

### Example of Processing Executed by Control Device

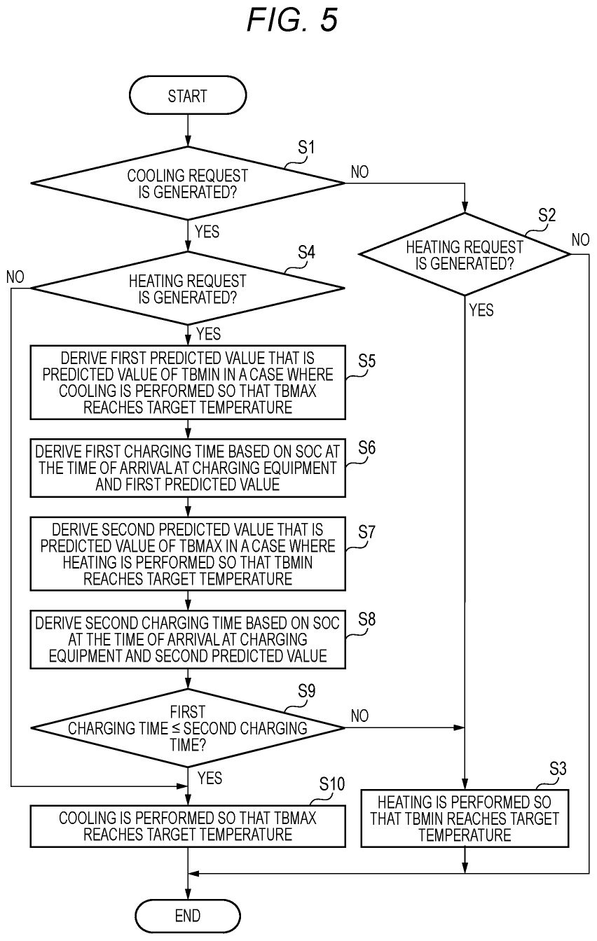

Next, an example of processing executed by the control device 17 will be described with reference to FIG. 5. For example, when an ignition power supply of the vehicle 10 is turned on, the control device 17 repeatedly executes a series of processing shown in FIG. 5 at a predetermined cycle.

First, the control device 17 determines whether a cooling request for cooling the battery 11 is generated before arrival at the charging equipment scheduled for charging (step S1). In the processing of step S1, the control device 17 determines that there is a cooling request on the condition that, for example, the distance or required time to the charging equipment scheduled for charging is equal to or less than a predetermined value and the first temperature TBMAX is equal to or higher than T1.

If it is determined that there is no cooling request (step S1: NO), the control device 17 determines whether a heating request for heating the battery 11 is generated before arrival at the charging equipment scheduled for charging (step S2). In the processing of step S2, the control device 17 determines that there is a heating request on the condition that, for example, the distance or required time to the charging equipment scheduled for charging is equal to or less than a predetermined value and the second temperature TBMIN is equal to or lower than T2

In a case where it is determined that there is no heating request (step S2: NO), the control device 17 ends a series of processing shown in FIG. 5. On the other hand, in a case where it is determined that there is a heating request (step S2: YES), the control device 17 heats the battery 11 so that the second temperature TBMIN reaches the target temperature Tg (step S3), and ends the series of processing shown in FIG. 5.

In a case where it is determined that there is a cooling request in the processing of step S1 (step S1: YES), the control device 17 determines whether a heating request is generated (step S4) as in the processing of step S2.

In a case where it is determined that there is no heating request (step S4: NO), the control device 17 proceeds to the processing of step S10 to be described later. On the other hand, in a case where it is determined that there is a heating request (step S4: YES), the control device 17 derives, based on the current temperature difference AT between the first temperature TBMAX and the second temperature TBMIN, a first predicted value TPI that is a predicted value of the second temperature TBMIN at the time of arrival at the charging equipment in a case where the battery 11 is cooled so that the first temperature TBMAX reaches the target temperature Tg (step S5).

Next, based on the SOC of the battery 11 at the time of arrival at the charging equipment and the first predicted value TP1, the control device 17 predicts a first charging time X that is a charging time at the charging equipment in the case where the battery 11 is cooled so that the first temperature TBMAX reaches the target temperature Tg (step S6).

Next, based on the current temperature difference AT between the first temperature TBMAX and the second temperature TBMIN, the control device 17 derives a second predicted value TP2 that is a predicted value of the first temperature TBMAX at the time of arrival at the charging equipment in a case where the battery 11 is heated so that the second temperature TBMIN reaches the target temperature Tg (step S7).

Next, based on the SOC of the battery 11 at the time of arrival at the charging equipment and the second predicted value TP2, the control device 17 predicts a second charging time Y that is a charging time at the charging equipment in the case where the battery 11 is heated so that the second temperature TBMIN reaches the target temperature Tg (step S8).

Next, the control device 17 compares the first charging time X derived in the processing of step S6 with the second charging time Y derived in the processing of step S8, and determines whether the first charging time X is equal to or less than the second charging time Y (step S9).

In a case where it is determined that the first charging time X is not equal to or less than the second charging time Y (step S9: NO), that is, in a case where it is determined that the second charging time Y is shorter than the first charging time X, the control device 17 proceeds to the processing of step S3 described above. On the other hand, in a case where it is determined that the first charging time X is equal to or less than the second charging time Y (step S9: YES), the control device 17 cools the battery 11 so that the first temperature TBMAX reaches the target temperature Tg (step S10), and ends the series of processing shown in FIG. 5.

As described above, according to the present embodiment, the first charging time X in the case where the battery 11 is cooled before arrival at the charging equipment scheduled for charging may be compared with the second charging time Y in the case where the battery 11 is heated before arrival at the charging equipment scheduled for charging, and the temperature of the battery 11 may be adjusted before arrival at the charging equipment based on the comparison result. Accordingly, before the vehicle 10 arrives at the charging equipment scheduled for charging, it is possible to appropriately adjust the temperature of the battery 11 having the plurality of battery modules 11m so that the charging time at the charging equipment becomes shorter. Therefore, it is possible to prevent the charging time from becoming longer and improve convenience. In addition, it is possible to improve marketability of the vehicle 10, promote electrification of automobiles including the vehicle 10, and contribute to improvement of energy efficiency.

Although an embodiment of the present disclosure has been described above, the present disclosure is not limited to the above embodiment, and modifications, improvements, and the like may be made as appropriate.

For example, in the above-described embodiment, in the case where the cooling request and the heating request conflict with each other, either the cooling or the heating is performed, but the present disclosure is not limited thereto. That is, in the case where the cooling request and the heating request conflict with each other, it may be more effective from the viewpoint of shortening the charging time that neither cooling nor heating is performed.

Therefore, in addition to the first charging time X and the second charging time Y described above, the control device 17 may predict a third charging time Z that is a charging time at the charging equipment in a case where the temperature of the battery 11 is not adjusted (that is, cooling and heating are not performed) before arrival at the charging equipment scheduled for charging. Among the first charging time X, the second charging time Y, and the third charging time Z, the control device 17 may adjust the temperature of the battery 11 (for example, cool the battery 11) so that the first temperature TBMAX reaches the target temperature Tg in a case where the first charging time X is the shortest, adjust the temperature of the battery 11 (for example, heat the battery 11) so that the second temperature TBMIN reaches the target temperature Tg in a case where the second charging time Y is the shortest, and not adjust the temperature of the battery 11 in a case where the third charging time Z is the shortest.

When predicting the third charging time Z, for example, the control device 17 first derives a third predicted value TP3 that is a predicted value of the first temperature TBMAX and/or a fourth predicted value TP4 that is a predicted value of the second temperature TBMIN at the time of arrival at the charging equipment in a case where the temperature of the battery 11 is not adjusted, based on the current first temperature TBMAX or the current second temperature TBMIN. The third predicted value TP3 may be predicted (derived) from, for example, a transition in the first temperature TBMAX in the past when the battery 11 is not cooled. Similarly, the fourth predicted value TP4 may be predicted (derived) from, for example, a transition in the second temperature TBMIN when the battery 11 is not heated in the past.

The control device 17 predicts the third charging time Z based on the SOC of the battery 11 at the time of arrival at the charging equipment and the third predicted value TP3 or the fourth predicted value TP4. As an example, the control device 17 derives a charging time (hereinafter also referred to as a “first candidate charging time”) associated with the SOC of the battery 11 at the time of arrival at the charging equipment and the first temperature TBMAX represented by the third predicted value TP3 with reference to the second charging time map M2. Further, the control device 17 derives a charging time (hereinafter, also referred to as a “second candidate charging time”) associated with the SOC of the battery 11 at the time of arrival at the charging equipment and the second temperature TBMIN represented by the fourth predicted value TP4 with reference to the first charging time map M1. The control device 17 compares the first candidate charging time with the second candidate charging time, and adopts the longer one as the third charging time Z.

In this way, among the first charging time X, the second charging time Y, and the third charging time Z, the temperature of the battery 11 is adjusted (for example, the battery 11 is cooled) so that the first temperature TBMAX reaches the target temperature Tg in the case where the first charging time X is the shortest, the temperature of the battery 11 is adjusted (for example, the battery 11 is heated) so that the second temperature TBMIN reaches the target temperature Tg in the case where the second charging time Y is the shortest, and the temperature of the battery 11 is not adjusted in the case where the third charging time Z is the shortest. Thus, even if a situation occurs in which the charging time is shortened by intentionally not performing temperature adjustment (that is, cooling and heating), the charging time may be shortened.

The control device 17 may derive only one of the first candidate charging time and the second candidate charging time described above, and may adopt the one as the third charging time Z. In this case, for example, if the first candidate charging time is adopted as the third charging time Z, the control device 17 may derive only the third predicted value TP3 among the third predicted value TP3 and the fourth predicted value TP4 described above, and derive the first candidate charging time (that is, the third charging time Z) based on the third predicted value TP3. On the other hand, if the second candidate charging time is adopted as the third charging time Z, the control device 17 may derive only the fourth predicted value TP4 among the third predicted value TP3 and the fourth predicted value TP4 described above, and derive the second candidate charging time (that is, the third charging time Z) based on the fourth predicted value TP4.

### Another Specific Example of Temperature Adjustment on Battery Performed by Control Device

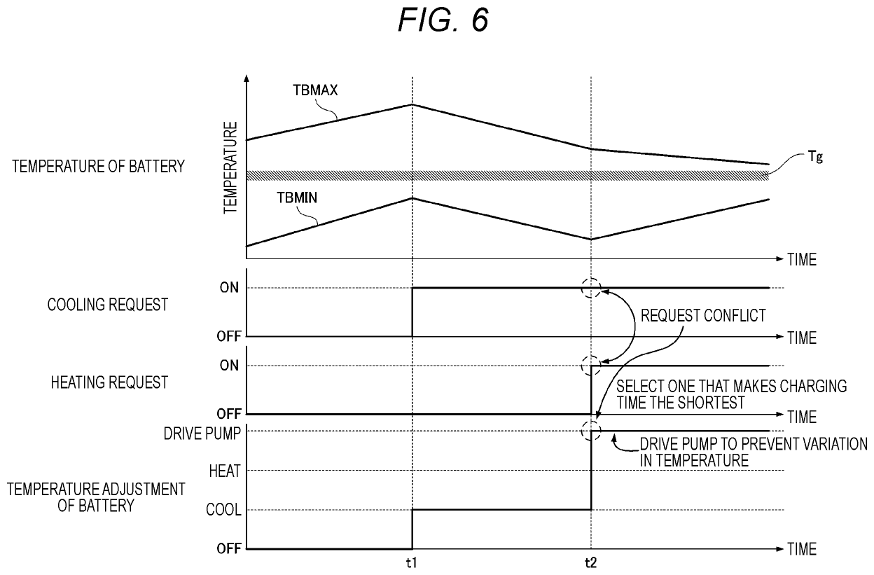

Next, another specific example of temperature adjustment on the battery 11 performed by the control device 17 will be described with reference to FIG. 6. Here, portions different from the description of FIG. 4 will be mainly described, and the description of portions common to the description of FIG. 4 will be appropriately omitted or simplified.

Similarly to the description of FIG. 4, in a case where the cooling request and the heating request conflict with each other at time t2, the control device 17 predicts the first charging time X, the second charging time Y, and the third charging time Z. Among the first charging time X, the second charging time Y, and the third charging time Z, the control device 17 cools the battery 11 so that the first temperature TBMAX reaches the target temperature Tg in a case where the first charging time X is the shortest, heats the battery 11 so that the second temperature TBMIN reaches the target temperature Tg in a case where the second charging time Y is the shortest, and does not adjust the temperature of the battery 11 in a case where the third charging time Z is the shortest. In the example shown in FIG. 6, since the third charging time Z is the shortest, the control device 17 does not perform cooling or heating from time t2.

As shown in FIG. 6, in this case, the control device 17 may drive the pump 15p from time t2 to circulate the temperature adjustment medium W, thereby preventing a variation in temperature among the battery modules 11m. For example, at this time, the control device 17 may drive the pump 15p in a state in which the power supply to the heating device 15b is stopped and the temperature adjustment medium W bypasses the cooling device 15a by the flow path switching valve 15v.

### Another Example of Processing Executed by Control Device

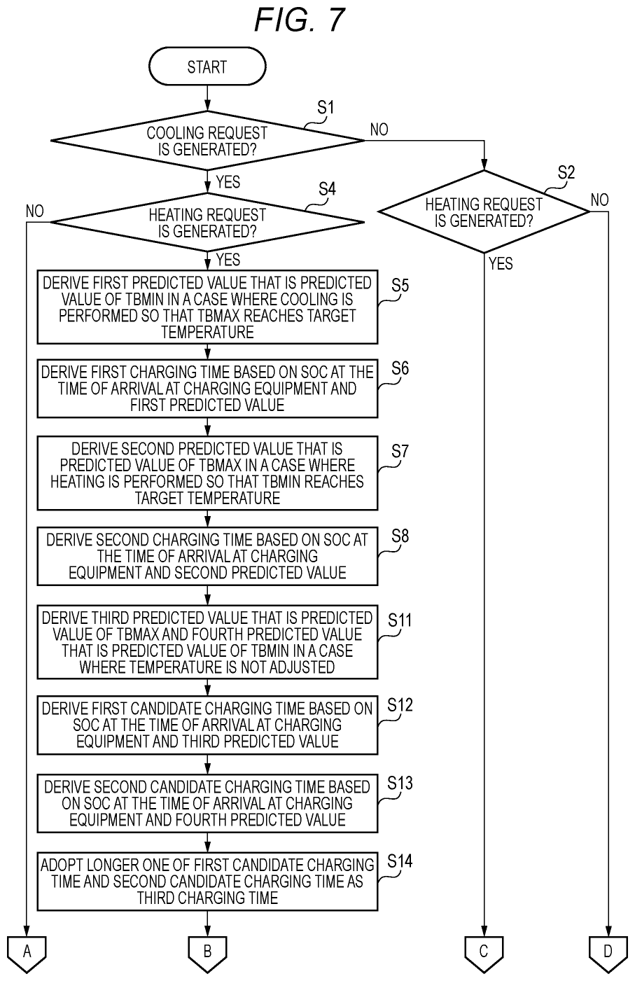

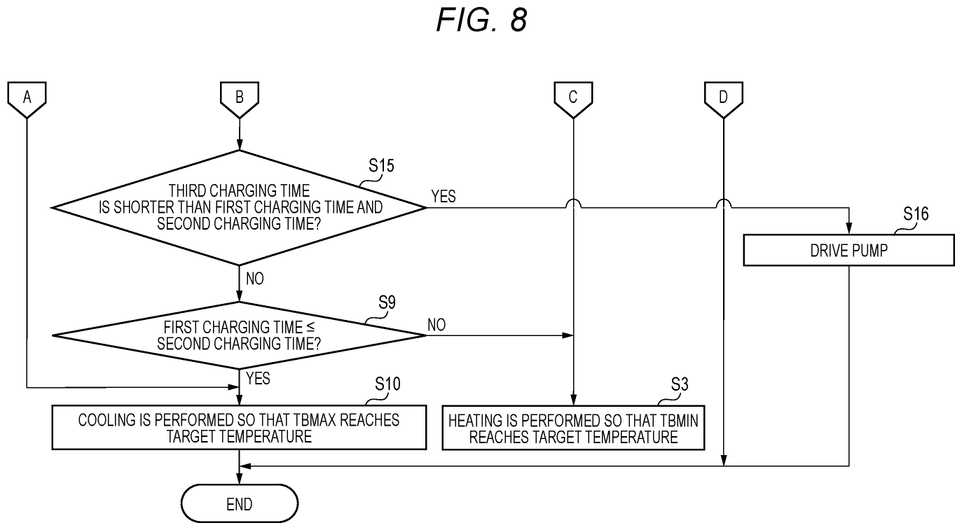

Next, an example of the processing executed by the control device 17 will be described with reference to FIGS. 7 and 8. Here, portions different from the description of FIG. 5 will be mainly described, and portions common to the description of FIG. 5 are denoted by the same reference numerals, and the description thereof will be appropriately omitted or simplified.

In the example, after the processing of step S7, the control device 17 derives the third predicted value TP3 that is the predicted value of the first temperature TBMAX and the fourth predicted value TP4 that is the predicted value of the second temperature TBMIN at the time of arrival at the charging equipment in the case where the temperature of the battery 11 is not adjusted, based on the current first temperature TBMAX or the current second temperature TBMIN (step S11).

Next, the control device 17 derives the above-described first candidate charging time based on the SOC of the battery 11 at the time of arrival at the charging equipment and the third predicted value TP3 (step S12). Further, the control device 17 derives the above-described second candidate charging time based on the SOC of the battery 11 at the time of arrival at the charging equipment and the fourth predicted value TP4 (step S13). The control device 17 compares the first candidate charging time derived in the processing of step S12 with the second candidate charging time derived in the processing of step S13, adopts the longer one as the third charging time Z (step S14), and proceeds to the processing of step S15 shown in FIG. 8.

Next, the control device 17 determines whether the third charging time Z is shorter than the first charging time X and the second charging time Y (step S15). In a case where it is determined that the third charging time Z is longer than the first charging time X and the second charging time Y (step S15: NO), the control device 17 proceeds to the processing of step S9 described above. On the other hand, in a case where it is determined that the third charging time Z is shorter than the first charging time X and the second charging time Y (step S15: YES), the control device 17 drives the pump 15p to prevent a variation in temperature among the battery modules 11m (step S16), and ends the series of processing shown in FIGS. 7 and 8.

Although an embodiment of the present disclosure has been described above with reference to the accompanying drawings, it is needless to say that the present disclosure is not limited to the embodiment described above. It is apparent that those skilled in the art may conceive of various modifications and changes within the scope described in the claims, and it is understood that such modifications and changes naturally fall within the technical scope of the present disclosure. In addition, the respective constituent elements in the above embodiment may be combined as desired without departing from the gist of the disclosure.

In the embodiment described above, an example in which the control device according to the present disclosure is implemented by the control device 17 mounted in the vehicle 10 is described, but the present disclosure is not limited thereto. For example, the control device according to the present disclosure may be implemented by a server that is communicatable with the control device 17. In this case, for example, the processing of the control device 17 described above may be performed by a processing unit implemented by a CPU of the server or the like. The control device according to the present disclosure may be implemented by cooperation between the control device 17 and the server, and for example, part of the processing of the control device 17 described above may be executed by the server.

The control method described in the embodiment described above may be implemented by executing a program prepared in advance on a computer (in other words, the processor). The program (control program) is stored in a computer-readable storage medium and is executed by being read from the storage medium. In addition, the program may be provided in a form stored in a nonvolatile (non-transitory) storage medium such as a flash memory, or may be provided via a network such as Internet. The computer that executes the program may be included in the vehicle 10 or may be included in an external device (for example, a server) that is communicatable with the vehicle 10.

In the present specification, at least the following matters are described. Although corresponding constituent elements in the embodiment described above are shown in parentheses, the present disclosure is not limited thereto.

(1) A control method of a vehicle (vehicle 10), the vehicle including a battery (battery 11) having a plurality of battery modules (battery modules 11m) and a temperature adjustment device (temperature adjustment device 15, cooling device 15a, heating device 15b) configured to adjust a temperature of the battery, the control method executed by a computer (control device 17), to control the vehicle, configured to adjust the temperature of the battery by the temperature adjustment device so that the temperature of the battery at a time of arrival at charging equipment reaches a predetermined target temperature (target temperature Tg) in a case where the battery is scheduled to be charged at the charging equipment included in a scheduled travel route of the vehicle, the control method including:
deriving, based on a temperature difference (temperature difference ΔT) between a first temperature (first temperature TBMAX) and a second temperature (second temperature TBMIN) at a present time, a first predicted value (first predicted value TP1) that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time (first charging time X) that is a charging time at the charging equipment in the case where the temperature of the battery is adjusted so that the first temperature reaches the target temperature;
deriving, based on the temperature difference, a second predicted value (second predicted value TP2) that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time (second charging time Y) that is a charging time at the charging equipment in the case where the temperature of the battery is adjusted so that the second temperature reaches the target temperature; and adjusting, based on a comparison result between the first charging time and the second charging time, the temperature of the battery so that the first temperature or the second temperature reaches the target temperature.

According to (1), it is possible to selectively perform either temperature adjustment such that the first battery module reaches the target temperature or temperature adjustment such that the second battery module reaches the target temperature based on the comparison result between the first charging time and the second charging time, the first charging time being a charging time at the charging equipment in a case where the temperature of the battery is adjusted so that the first battery module having a relatively high temperature reaches the predetermined target temperature, and the second charging time being a charging time at the charging equipment in a case where the temperature of the battery is adjusted so that the second battery module having a relatively low temperature reaches the predetermined target temperature. Accordingly, before the vehicle arrives at a charging equipment scheduled for charging, it is possible to appropriately adjust the temperature of the battery having the plurality of battery modules so that the charging time at the charging equipment becomes shorter.

Therefore, it is possible to prevent the charging time from becoming longer and improve convenience. This further contributes to improvement in energy efficiency.

(2) The control method according to (1), further including:
adjusting the temperature of the battery so that the first temperature reaches the target temperature in response to the first charging time being shorter than the second charging time; and
adjusting the temperature of the battery so that the second temperature reaches the target temperature in response to the second charging time being shorter than the first charging time.

According to (2), among the temperature adjustment such that the first battery module having a relatively high temperature reaches the target temperature and the temperature adjustment such that the second battery module having a relatively low temperature reaches the target temperature, it is possible to perform the one that makes the charging time at the charging equipment scheduled for charging shorter, and it is possible to appropriately adjust the temperature so that the charging time at the charging equipment becomes shorter.

(3) The control method according to (1), further including:
predicting the first charging time based on the remaining capacity of the battery at the time of arrival at the charging equipment, the first predicted value, and output performance of the charging equipment; and
predicting the second charging time based on the remaining capacity of the battery at the time of arrival at the charging equipment, the second predicted value, and the output performance of the charging equipment.

According to (3), it is possible to selectively perform either the temperature adjustment such that the first battery module having a relatively high temperature reaches the target temperature or temperature adjustment such that the second battery module having a relatively low temperature reaches the target temperature in consideration of the output performance (for example, upper limit output) of the charging equipment.

(4) The control method according to any one of (1) to (3), further including:
deriving, based on the current first temperature or the current second temperature, a third predicted value that is a predicted value of the first temperature or a fourth predicted value that is a predicted value of the second temperature at the time of arrival at the charging equipment in a case where the temperature of the battery is not adjusted;
predicting a third charging time that is a charging time at the charging equipment in the case where the temperature of the battery is not adjusted, based on the remaining capacity of the battery at the time of arrival at the charging equipment and the third predicted value or the fourth predicted value;
adjusting the temperature of the battery so that the first temperature reaches the target temperature in a case where the first charging time is the shortest among the first charging time, the second charging time, and the third charging time;
adjusting the temperature of the battery so that the second temperature reaches the target temperature in a case where the second charging time is the shortest among the first charging time, the second charging time, and the third charging time; and
not adjusting the temperature of the battery in a case where the third charging time is the shortest among the first charging time, the second charging time, and the third charging time.

According to (4), even if a situation occurs in which the charging time at the charging equipment scheduled for charging is shortened by intentionally not performing temperature adjustment (that is, cooling and heating), the charging time may be shortened.

(5) A control device that controls a vehicle including a battery having a plurality of battery modules and a temperature adjustment device configured to adjust a temperature of the battery, in which
the control device is configured to
adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, and
the control device includes a processing unit configured to perform the following processing:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.

According to (5), it is possible to selectively perform either temperature adjustment such that the first battery module reaches the target temperature or temperature adjustment such that the second battery module reaches the target temperature based on the comparison result between the first charging time and the second charging time, the first charging time being a charging time at the charging equipment in a case where the temperature of the battery is adjusted so that the first battery module having a relatively high temperature reaches the predetermined target temperature, and the second charging time being a charging time at the charging equipment in a case where the temperature of the battery is adjusted so that the second battery module having a relatively low temperature reaches the predetermined target temperature. Accordingly, before the vehicle arrives at a charging equipment scheduled for charging, it is possible to appropriately adjust the temperature of the battery having the plurality of battery modules so that the charging time at the charging equipment becomes shorter. Therefore, it is possible to prevent the charging time from becoming longer and improve convenience. This further contributes to improvement in energy efficiency.

(6) A vehicle including:
a battery having a plurality of battery modules;
a temperature adjustment device configured to adjust a temperature of the battery; and
a control device configured to adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, in which
   the control device includes a processing unit configured to perform a process including:
      deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
      predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
      deriving, based on the temperature difference, a second predicted value that is a predicted value of the first temperature at the time of arrival at the charging equipment in a case where the temperature of the battery is adjusted so that the second temperature reaches the target temperature;
      predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
      adjusting, based on a comparison result between the first charging time and the second charging time, the temperature of the battery so that the first temperature or the second temperature reaches the target temperature.

According to (6), it is possible to selectively perform either temperature adjustment such that the first battery module reaches the target temperature or temperature adjustment such that the second battery module reaches the target temperature based on the comparison result between the first charging time and the second charging time, the first charging time being a charging time at the charging equipment in a case where the temperature of the battery is adjusted so that the first battery module having a relatively high temperature reaches the predetermined target temperature, and the second charging time being a charging time at the charging equipment in a case where the temperature of the battery is adjusted so that the second battery module having a relatively low temperature reaches the predetermined target temperature. Accordingly, before the vehicle arrives at a charging equipment scheduled for charging, it is possible to appropriately adjust the temperature of the battery having the plurality of battery modules so that the charging time at the charging equipment becomes shorter. Therefore, it is possible to prevent the charging time from becoming longer and improve convenience. This further contributes to improvement in energy efficiency.

What is claimed is:

1. A control method of a vehicle, the vehicle including a battery having a plurality of battery modules and a temperature adjustment device configured to adjust a temperature of the battery, the control method executed by a computer, to control the vehicle, configured to adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, the control method comprising:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.

2. The control method according to claim 1, further comprising:
adjusting the temperature of the battery so that the first temperature reaches the target temperature in response to the first charging time being shorter than the second charging time; and
adjusting the temperature of the battery so that the second temperature reaches the target temperature in response to the second charging time being shorter than the first charging time.

3. The control method according to claim 1, further comprising:
predicting the first charging time based on the remaining capacity of the battery at the time of arrival at the charging equipment, the first predicted value, and output performance of the charging equipment; and
predicting the second charging time based on the remaining capacity of the battery at the time of arrival at the charging equipment, the second predicted value, and the output performance of the charging equipment.

4. The control method according to claim 1, further comprising:
deriving, based on the current first temperature or the current second temperature, a third predicted value that is a predicted value of the first temperature or a fourth predicted value that is a predicted value of the second temperature at the time of arrival at the charging equipment in a case where the temperature of the battery is not adjusted;
predicting a third charging time that is a charging time at the charging equipment in the case where the temperature of the battery is not adjusted, based on the remaining capacity of the battery at the time of arrival at the charging equipment and the third predicted value or the fourth predicted value;
adjusting the temperature of the battery so that the first temperature reaches the target temperature in a case where the first charging time is the shortest among the first charging time, the second charging time, and the third charging time;
adjusting the temperature of the battery so that the second temperature reaches the target temperature in a case where the second charging time is the shortest among the first charging time, the second charging time, and the third charging time; and
not adjusting the temperature of the battery in a case where the third charging time is the shortest among the first charging time, the second charging time, and the third charging time.

5. A control device that controls a vehicle including a battery having a plurality of battery modules and a temperature adjustment device configured to adjust a temperature of the battery, wherein
the control device is configured to
adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, and
the control device comprises a processing unit configured to perform the following processing:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.

6. A vehicle comprising:
a battery having a plurality of battery modules;
a temperature adjustment device configured to adjust a temperature of the battery; and
a control device configured to adjust the temperature of the battery by the temperature adjustment device so that the temperature of the battery at a time of arrival at charging equipment reaches a predetermined target temperature in a case where the battery is scheduled to be charged at the charging equipment included in a scheduled travel route of the vehicle, wherein
the control device includes a processing unit configured to perform a process including:
deriving, based on a temperature difference between a first temperature and a second temperature at a present time, a first predicted value that is a predicted value of the second temperature at the time of arrival at the charging equipment in a case where the temperature of the battery is adjusted so that the first temperature reaches the target temperature, the first temperature being a temperature of a first battery module having a relatively high temperature among the plurality of battery modules and the second temperature being a temperature of a second battery module having a relatively low temperature among the plurality of battery modules;
predicting, based on a remaining capacity of the battery at the time of arrival at the charging equipment and the first predicted value, a first charging time that is a charging time at the charging equipment in the case where the temperature of the battery is adjusted so that the first temperature reaches the target temperature;
deriving, based on the temperature difference, a second predicted value that is a predicted value of the first temperature at the time of arrival at the charging equipment in a case where the temperature of the battery is adjusted so that the second temperature reaches the target temperature;
predicting, based on the remaining capacity of the battery at the time of arrival at the charging equipment and the second predicted value, a second charging time that is a charging time at the charging equipment in the case where the temperature of the battery is adjusted so that the second temperature reaches the target temperature; and
adjusting, based on a comparison result between the first charging time and the second charging time, the temperature of the battery so that the first temperature or the second temperature reaches the target temperature.
